(19) United States
(12) Patent Application Publication
(10) Pub. No.: US 2019/0092182 A1
(43) Pub. Date: Mar. 28, 2019

(54) A SYSTEM FOR EFFICIENT CHARGING OF DISTRIBUTED VEHICLE BATTERIES

(71) Applicant: CATERVA GMBH, Pullach (DE)

(72) Inventor: Roland GERSCH, Munich (DE)

(73) Assignee: CATERVA GMBH, Pullach (DE)

(21) Appl. No.: 16/085,802

(22) PCT Filed: Mar. 16, 2017
(86) PCT No.: PCT/EP2017/056262

§ 371 Date: Sep. 17, 2018

(30) Foreign Application Priority Data
Mar. 18, 2016 (EP) PCT/EP2016/055984

(51) Int. Cl. B60L 11/18; H02J 7/00

(52) U.S. Cl. CPC B60L 11/1844; H02J 7/0021; B60L 11/1824

(57) ABSTRACT

A system for efficient charging of distributed vehicle batteries of vehicles, wherein each vehicle battery is connectable to a battery charger connected to a power supply grid via an electromechanical switch of a switching battery controller communicating with a control center of the system, wherein the control center is adapted to provide a switching schedule for the electromechanical switch of the respective switching battery controller on the basis of power absorption predictions calculated by said control center for the switching battery controllers in response to power measurements reported by the switching battery controllers and on the basis of power absorption schedules and/or power generation schedules of energy resources of said power supply grid.

The invention relates to a system and a method for efficient charging of distributed vehicle batteries which are connectable to battery chargers having a connection with a power supply grid.

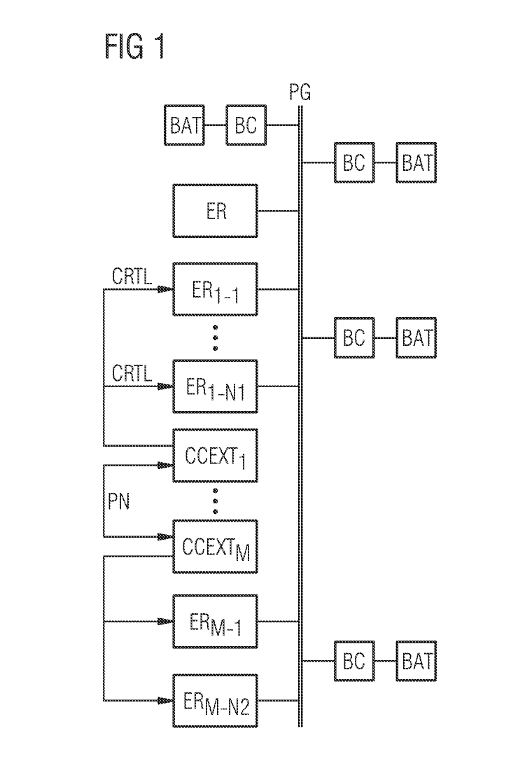

FIG. 1 shows a conventional power supply grid PG. As can be seen in FIG. 1, a plurality of distributed batteries BAT is connected to the power supply grid PG by means of a battery charger BC. The battery chargers extract energy and power from the power supply grid to charge the respective battery BAT. Further, also other consumers can be connected to the power supply grid PG (not shown in FIG. 1). A plurality of different energy resources ER are connected to the power supply grid as shown in FIG. 1. An energy resource can be a controllable power consumer, controllable power generator or a controllable device for storing energy. In the exemplary European power transmission grid, most of the energy resources are controlled by external control centers CCEXT. In the example, these control centers CCEXT are control centers of power plant operators. There can be different power plant operators each running a number of energy resources ER as shown in FIG. 1. In the example of the European power transmission grid, energy resources ER comprise renewable energy resources such as wind turbines or photovoltaic power generation plants, conventional energy resources such as gas turbine power plants as well as batteries. The different control centers CCEXTi of the different energy resources can be connected to each other by means of a private network PN to communicate with each other. To stabilize the power supply grid PG normally grid parameters such as local voltage and grid-wide frequency can be measured. An alternating current power supply grid PG usually has a predetermined operation frequency. This operation frequency is for instance in the European transmission grid 50 Hz. If the operation frequency of the power supply grid PG drops beneath a predetermined threshold value additional energy resources ER are activated to stabilize the power supply grid, already active energy resources increase their electrical power supply to or decrease their power consumption from the power supply grid. On the contrary, if the operation frequency of the power supply grid becomes too high energy resources are deactivated, reduce their electrical power supply to or increase their power consumption from the power supply grid in order to stabilize the power supply grid.

A drawback of the conventional power supply system as illustrated in FIG. 1 is that it is necessary to provide flexible energy resources to stabilize the power supply grid in response to a changing energy demand of a plurality of consumers. With increasing electromobility, the number of batteries BAT connected to the power supply grid PG does increase significantly. The batteries BAT can comprise batteries of vehicles comprising cars and trucks having electric motors powered by the energy stored in the batteries BAT of the vehicle. In the conventional power supply system, a plurality of different vehicle owners may try to load their respective batteries BAT at the same time. To balance this potential peak power demand, a conventional power supply system has to provide many matching flexible energy resources which can be activated on short notice in case that a peak power supply demand occurs to stabilize the power supply grid.

Accordingly, it is an object of the present invention to provide a method and a system for efficient charging of distributed batteries allowing to reduce the necessary power supply capacity provided by flexible energy resources.

An advantage of the present invention is that it can accomplish the efficient charging of vehicle batteries without requiring the charging devices to also be discharging devices.

This object is achieved by a system for efficient charging of distributed batteries comprising the features of claim 1.

The invention provides according to a first aspect a system for efficient charging of distributed vehicle batteries of vehicles,

wherein each vehicle battery is connectable to a battery charger connected to a power supply grid via an electromechanical switch of a switching battery controller communicating with a control center of the system,
wherein the control center is adapted to provide a switching schedule for the electromechanical switch of the respective switching battery controller on the basis of power absorption predictions calculated by said control center for the switching battery controllers in response to power measurements reported by the switching battery controllers and on the basis of power absorption schedules and/or power generation schedules of energy resources of the power supply grid.

In a possible embodiment of the system according to the first aspect of the present invention, the control center is adapted to provide a switching schedule for the electromechanical switch of the switching battery controller also on the basis of charging modes selected by users of vehicles.

In a still further possible embodiment of the system according to the first aspect of the present invention, the charging mode for charging the vehicle battery of the vehicle by the battery charger is selected by a user of the vehicle via a user interface.

In a still further possible embodiment of the system according to the first aspect of the present invention, the selectable charging mode comprises

a first charging mode where the connected vehicle battery is charged by the battery charger with a maximum charging rate, a second charging mode where the connected vehicle battery is charged by the battery charger under control of the switching battery controller communicating with the control center and a third charging mode where the connected vehicle battery is charged by the battery charger according to a charging time plan input by a user of the vehicle and/or derived automatically from a driving routine of the vehicle.

In a further possible embodiment of the system according to the first aspect of the present invention, the user interface comprises a user interface implemented in a handheld mobile device of a user and/or a user interface implemented in the vehicle comprising the rechargeable vehicle battery.

In a further possible embodiment of the system according to the first aspect of the present invention, the charging mode selected by a user by means of the user interface is notified wireless to the control center of the system which is adapted to provide the switching schedule for the electromechanical switch of the switching battery controller depending on the charging modes selected by users of different vehicles.

In a still further possible embodiment of the system according to the first aspect of the present invention, an electrical power reserved by the control center of the system for charging a vehicle battery of a specific user is adapted by the control center of the system depending on the charging mode selected by the respective user via the user interface.

In a still further possible embodiment of the system according to the first aspect of the present invention, the reserved electrical power associated with a vehicle battery of a specific user is reduced automatically if the user selects the first charging mode and is increased automatically if the user selects the second charging mode and/or wherein the reserved electrical power associated with the vehicle battery of a specific user is changed depending on a charging time plan input by the user or derived from the driving routine of the vehicle in the third charging mode.

In a possible embodiment of the system according to the first aspect of the present invention, the control center is adapted to determine the switching schedule for the low-frequency switch of the switching battery controller in response to the calculated power absorption predictions, the power absorption schedules and/or power generation schedules of the energy resources and in response to the monitored power grid parameters.

In a possible embodiment of the system according to the first aspect of the present invention, the switching battery controller comprises a processor adapted to communicate with said control center via a communication interface of the switching battery controller and adapted to control the low-frequency switch of the switching battery controller according to the switching schedule determined by the control center for the low-frequency switch of the switching battery controller and received by said processor through the communication interface of the switching battery controller.

In a further possible embodiment of the system according to the first aspect of the present invention, the switching battery controller comprises a metering unit adapted to measure a current power absorbed by a battery charger connected to the low-frequency switch of the switching battery controller and to report the measured power absorption to the control center which is adapted to calculate power absorption predictions based on previously reported power absorptions.

In a further possible embodiment of the system according to the first aspect of the present invention, the control center is adapted to calculate power absorption predictions for a specific time period by evaluating previously reported absorptions of at least one corresponding time period in the past reported under matching circumstances.

In a further possible embodiment of the system according to the first aspect of the present invention, the control center is connected to at least one external control center of energy resources to receive planned power absorption schedules and/or power generation schedules for the energy resources controlled by the respective external control center.

In a further possible embodiment of the system according to the first aspect of the present invention, the control center is adapted to calculate for at least one monitored power grid parameter a power absorption schedule and/or power generation schedule for the batteries based on the deviation from a predetermined parameter target value of the at least one monitored power grid parameter.

In a further possible embodiment of the system according to the first aspect of the present invention, the control center is adapted to receive duty power absorption schedules for the entirety of batteries from at least one external control center.

In a further possible embodiment of the system according to the first aspect of the present invention, the control center is adapted to calculate switching schedules against planned power absorption schedules and/or power generation schedules for energy resources, duty power absorption and/or power generation schedules for the batteries and/or power absorption schedules and/or power generation schedules for the batteries based on a deviation from a predetermined parameter target value of at least one monitored power grid parameter.

In a further possible embodiment of the system according to the first aspect of the present invention, the control center is adapted to sum up at least one of the planned power absorption schedules and/or power generation schedules for the energy resources controlled by at least one external control center, all the duty power absorption and/or power generation schedules for the batteries, the power absorption schedules and/or power generation schedules for the batteries based on a deviation from a predetermined parameter target value of at least one monitored power grid parameter to calculate a candidate schedule.

In a further possible embodiment of the system according to the first aspect of the present invention, the control center is adapted to predict the power absorption and/or power generation of the entirety of batteries connected to the control center based on a candidate schedule.

In a further possible embodiment of the system according to the first aspect of the present invention, the control center is adapted to optimize the calculated candidate schedule on the basis of a utility of energy stored in the distributed batteries and/or life expectancy impacts of charging processes on the distributed batteries by varying the at least one planned power absorption schedule and/or power generation schedule for the energy resources controlled by the at least one external control center included in the summation.

In a further possible embodiment of the system according to the first aspect of the present invention, the metering units of the switching battery controllers are connected via a communication infrastructure to a virtual meter of the central controller.

The invention further provides according to a second aspect a method for efficient charging of distributed batteries comprising the features of claim 20.

The invention provides according to the second aspect a method for efficient charging of distributed vehicle batteries of vehicles, wherein each vehicle battery is connectable to a battery charger connected to a power supply grid via an electromechanical switch of a switching battery controller,

wherein the method comprises the following steps:
calculating by a control center for all switching battery controllers power absorption predictions in response to power measurements reported by the switching battery controllers to the control center, and
controlling the electromechanical switch of a switching battery controller according to a switching schedule determined for the respective electromechanical switch by the control center on the basis of the calculated power absorption characteristics and on the basis of power absorption and power generation schedules of energy resources of the power supply grid.

In a possible embodiment of the method according to the second aspect of the present invention, the switching schedule is determined by the control center also on the basis of charging modes selected by users of the vehicles.

The invention further provides according to a third aspect a switching battery controller for a rechargeable battery comprising the features of claim 22.

The invention provides according to the third aspect a switching battery controller for a rechargeable battery of a vehicle, said switching battery controller comprising

an electromechanical switch connected to a battery charger of said rechargeable vehicle battery,
a processor adapted to control the electromechanical switch according to a switching schedule received from a control center by a communication interface of the switching battery controller,
wherein the switching schedule is determined by the control center on the basis of calculated power absorption characteristics and on the basis of power absorption and power generation schedules of energy resources of the power supply grid, and
a metering unit adapted to measure a current power absorbed by the battery charger and adapted to report the measured power absorption via the communication interface of the switching battery controller to the control center.

The invention further provides according to a fourth aspect a control center comprising the features of claim 23.

The invention provides according to the fourth aspect a control center for a system according to the first aspect of the present invention, wherein the control center is adapted to provide a switching schedule for different switching battery controllers on the basis of power absorption predictions calculated by the control center for all switching battery controllers in response to power measurements reported by the switching battery controllers and on the basis of power absorption and/or power generation schedules of energy resources of the power supply grid.

In a possible embodiment of the control center according to the fourth aspect of the present invention, the control center is further adapted to provide a switching schedule also on the basis of the charging modes selected by users of vehicles.

In the following, possible embodiments of the different aspects of the present invention are described in more detail with reference to the enclosed figures.

FIG. 1 shows a block diagram of a conventional power supply system for illustrating a problem underlying the present invention;

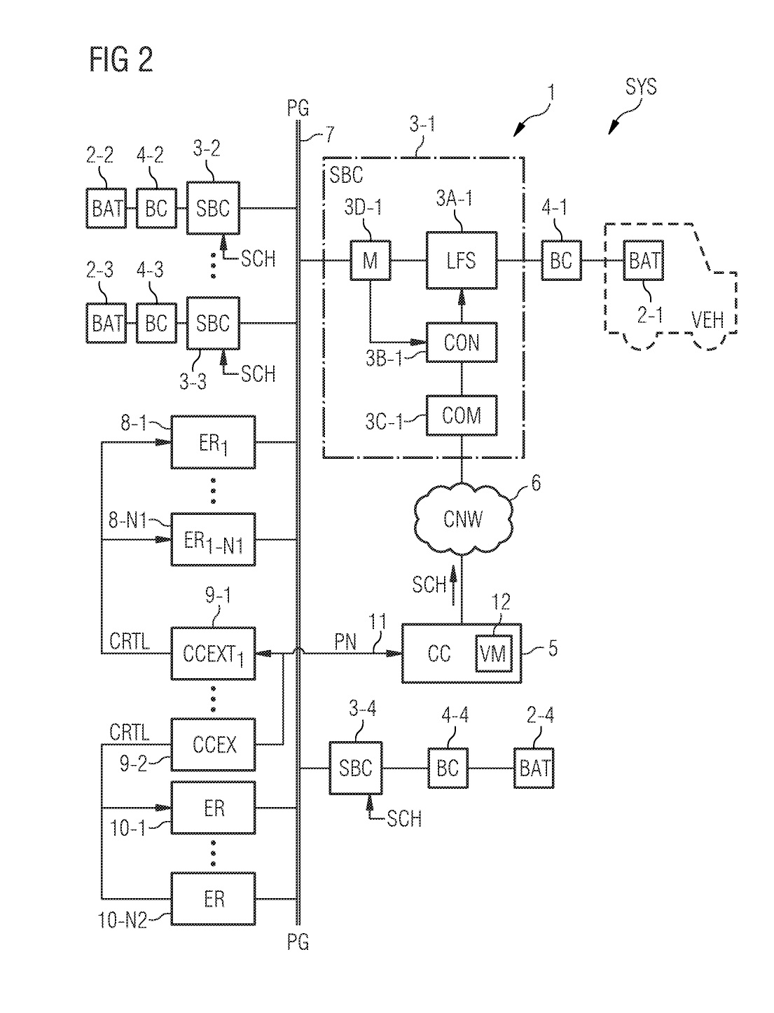

FIG. 2 shows a block diagram of a possible exemplary embodiment of a system for efficient charging of distributed vehicle batteries according to the first aspect of the present invention;

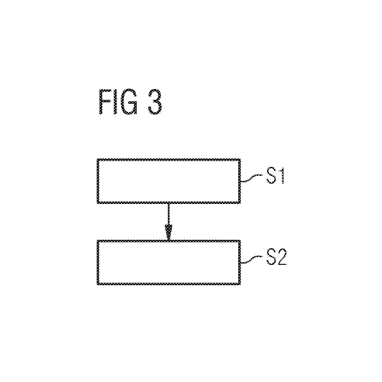

FIG. 3 shows a flowchart of a possible exemplary embodiment of a method for efficient charging of distributed batteries according to a further aspect of the present invention;

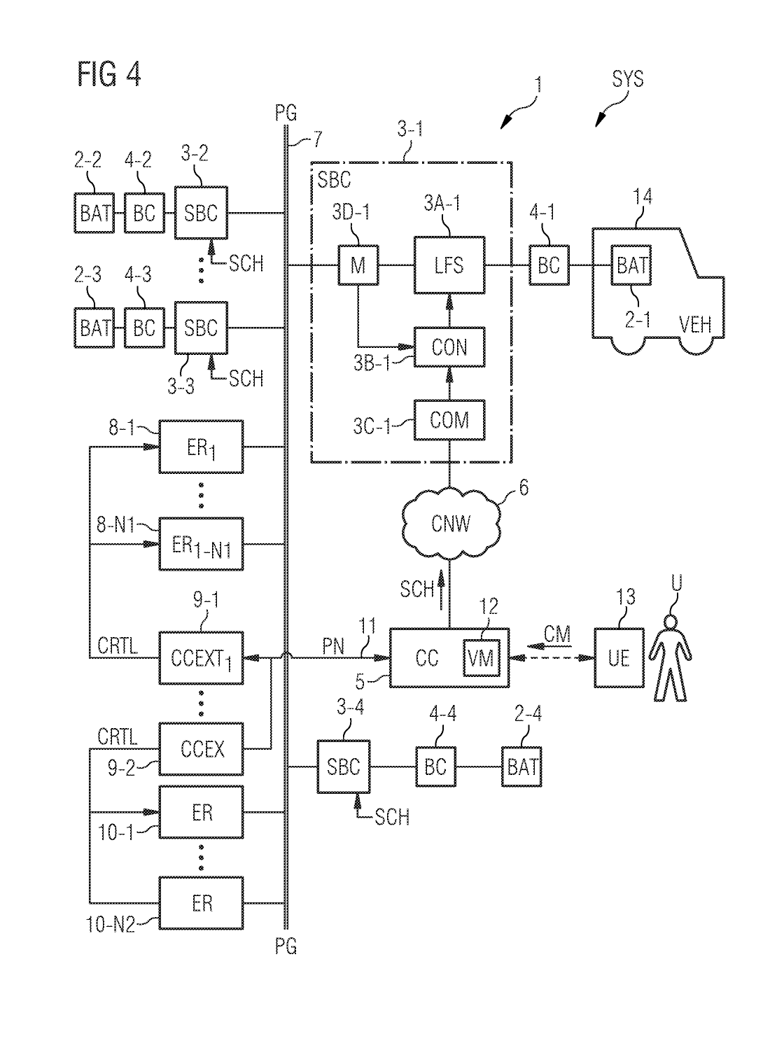

FIG. 4 shows a block diagram of a possible exemplary embodiment of a system for efficient charging of distributed vehicle batteries according to the first aspect of the present invention;

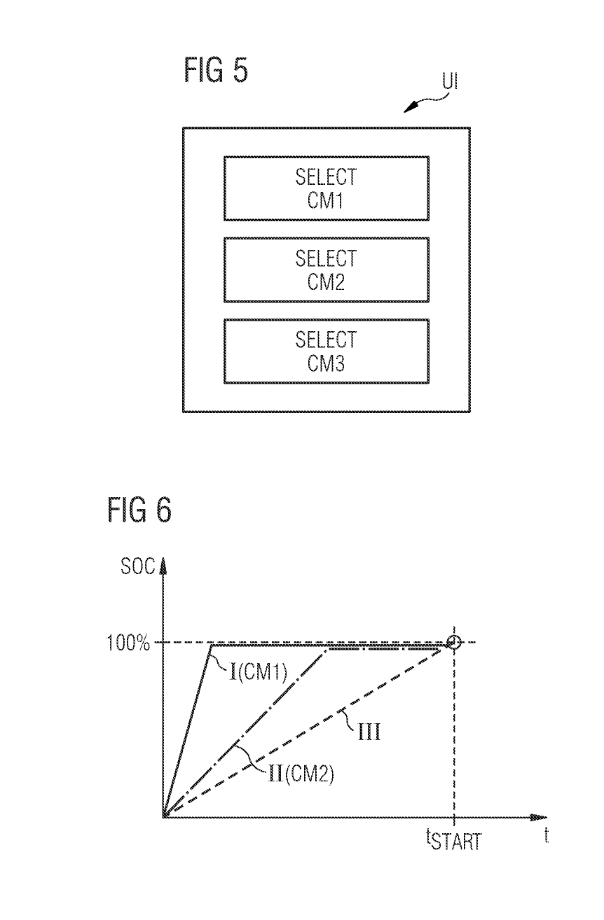

FIG. 5 shows an exemplary implementation of a user interface for selecting different charging modes by users according to the present invention;

FIG. 6 shows schematically charging diagrams for illustrating the operation of a possible exemplary embodiment of a method and system according to the present invention;

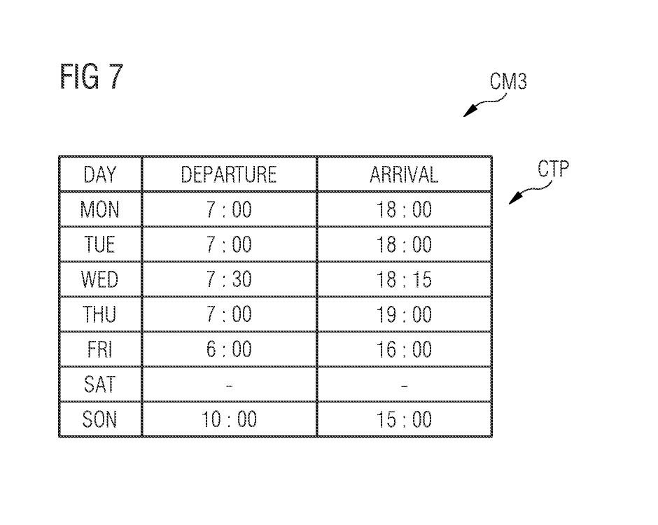

FIG. 7 shows an exemplary time plan which can be input by a user in the third charging mode.

As can be seen in FIG. 2, a system 1 for efficient charging of distributed batteries 2-1, 2-2, 2-3, 2-4 of vehicles can comprise a number of switching battery controllers 3-1, 3-2, 3-3, 3-4. The vehicle batteries 2-i can be connected to an associated switching battery controller 3-i by means of a battery charger 4-i as shown in FIG. 2. A user of a vehicle such as a car, truck, e-bike, etc. can plug the vehicle battery 2 or a charging cable of the vehicle into the battery charger 4 for charging the vehicle battery 2. In the illustrated embodiment of FIG. 2, the switching battery controller 3-i comprises a low-frequency switch, a processor, a metering unit and a communication interface. The switching battery controller 3-1 as illustrated in FIG. 2 is expanded to show its internal structure which comprises a low-frequency switch 3A-1, a processor 3B-1, a communication interface 3C-1 and a metering unit 3D-1. The processor 3B of a switching battery controller (SBC) 3 is adapted to control the switch 3A of the respective switching battery controller 3. Further, the processor 3B is adapted to communicate with a control center 5 via a communication interface 3C of the switching battery controller 3. The communication interface 3C is connected via a communication network 6 to the communication center 5 of the system 1. The communication network 6 can for instance be a communication data network such as the internet. In an alternative embodiment, the communication network 6 can be formed by a telephone network. In a still further possible embodiment, the communication network 6 can also be formed by the powerlines of a power supply grid using powerline communication PLC. As shown in FIG. 2, a plurality of switching battery controllers 3-i can be connected to powerlines of a common power supply grid 7 adapted to supply power to a plurality of power consuming devices including a plurality of distributed batteries to be loaded. As can be seen in FIG. 2, the power supply grid 7 can receive power from energy resources 8-1, 8-n1 controlled by a first external control center 9-1 and from a second group of energy resources 10-1 to 10-n2 controlled by another external control center 9-2. The external control centers 9-1, 9-2 of the system 1 can be for instance control centers of different power plant operators. The energy resources 8, 10 can comprise renewable and non-renewable energy resources. In the embodiment illustrated in FIG. 2, the external control centers 9-1, 9-2 are connected via a private communication network 11 to exchange data.

In the system 1 shown in FIG. 2, a plurality of distributed vehicle batteries 2-i can be connected for charging the vehicle batteries to the power supply grid 7 via the low-frequency electromechanical switch 3A of the switching battery controller 3. The switching battery controller 3 is adapted to communicate with the control center 5 of the system 1 via the communication interface 3C and the communication network 6. The control center 5 is adapted to provide a switching schedule SCH for the low-frequency switch 3A of the switching battery controller 3 on the basis of power absorption predictions calculated by the control center 5 for the switching battery controllers 3 in response to power measurements reported by the switching battery controllers 3 and on the basis of power absorption schedules and/or power generation schedules of energy resources 8, 10 connected to the power supply grid 7. As shown in FIG. 2, the control center 5 is connected to the external control centers 9-1, 9-2 of the system 1 by means of the private communication network 11. Based on all information data received and predicted, the control center 5 is adapted to calculate an optimal switching schedule SCH for the different switching battery controllers 3 and to supply the calculated switching schedule SCH to the different switching battery controllers 3 via the same or different communication networks 6 as illustrated in FIG. 2. The control center 5 can send the calculated switching schedule SCH over the communication network 6 to the communication interface 3C of the switching battery controller 3 from where it is forwarded to the processor 3B of the switching battery controller 3. In a preferred embodiment, the control center 5 has access to measurements and forecasts regarding the environment of the power supply system, in particular temperature, wind strength, cloud cover or rainfall. Further, the communication center 5 can have access to measurements regarding the grid status of the power supply grid 7, in particular the grid operation frequency and/or a root-mean-square voltage. The control center 5 is adapted to determine the switching schedule SCH for the low-frequency switches 3A of the different switching battery controllers 3 in response to calculated power absorption predictions, power absorption schedules and/or in response to power generation schedules of the energy resources 8, 10 and/or in response to monitored power grid parameters of the power supply grid 7. The schedules of the energy resources 8, 10 can be received from the control centers 9-1, 9-2 of the power plant operators by the control center 5 via the private network 11.

The processor 3B of a switching battery controller 3 is adapted to control the low-frequency switch 3A of the switching battery controller 3 according to the received switching schedule SCH received from the control center 5 for the respective low-frequency switch 3A of the switching battery controller 3. In a possible embodiment, the low-frequency switch 3A controlled by the processor 3B is formed by an electromechanical switch. The low-frequency switch 3A is adapted to separate the battery charger 4 from the power supply grid 7 when opened or switched off. The low-frequency switch 3A can be in a possible implementation a switch which is able to open between once every 10 seconds and once every 15 minutes. This is a low-switching frequency compared to conventional switches for battery charging which may open or even invert several thousand times per second. Consequently, the low-frequency switch 3A used within the switching battery controller 3 can be implemented by a switch of a simpler type, for instance a electromechanical switch instead of a semiconducting switch, thus reducing the necessary complexity of the switching battery controller 3. The low switching frequency also makes the use of electromagnetic filters to control the harmonics of the switching action unnecessary.

The switching battery controller 3 further comprises a metering unit 3D adapted to measure a current power absorbed by the battery charger 4 connected to the low-frequency electromechanical switch 3A of the switching battery controller 3. The metering unit 3D is further adapted to report the measured power absorption to the control center 5 which is adapted to calculate power absorption predictions based on previously reported power absorptions. The metering unit 3D measures the current power absorbed by the battery charger 4 and sends the measured current power value to the local controller or processor of the switching battery controller 3. The processor 3B of the switching battery controller 3 does then send the measured current absorbed power via the communication network 6 to the control center 5. Accordingly, the control center 5 receives from a plurality of different switching battery controllers 3-i reported measured power absorption values and can calculate power absorption predictions based on the received reported power absorptions. In a preferred embodiment, the control center 5 comprises a processing unit which is adapted to calculate power absorption predictions for a specific time period by evaluating previously reported absorptions of at least one corresponding time period in the past reported under matching circumstances. For instance the control center 5 can be adapted to calculate power absorption predictions based on previously reported power absorption measurements by extrapolating patterns from comparable days of the week, comparable weather conditions and/or comparable weeks within the same year. In a possible implementation, the control center 5 can copy the power absorption pattern from the same day of a week, within the same week of a year from a previous year, except if the temperature T at the time was more than e.g. 5 degrees different than the current temperature T. In this case, the control center 5 could copy the pattern from the previous or next week of the year whichever one has the most similar temperature. Accordingly, the control center 5 used within the system 1 according to the present invention comprises a predictive capability providing an advantage because this allows the connection of different types and sizes of batteries 2-i and battery chargers 4 without having to develop an optimization algorithm for each type and size of batteries and battery chargers.

The control center 5 is connected to the at least one external control centers 9-1, 9-2 of energy resources 8, 10 to receive planned power absorption schedules and/or power generation schedules for the energy resources controlled by the respective external control centers 9-1, 9-2. The control center 5 is adapted to calculate for at least one monitored power grid parameter a power absorption schedule and/or power generation schedule for the batteries 2-i based on the deviation from a predetermined parameter target value of the at least one monitored power grid parameter. The power grid parameter can comprise an operation power supply frequency of an AC power supply grid 7. The monitored power grid parameter can also comprise a power supply voltage of the power supply grid 7.

In a possible embodiment, the control center 5 is adapted to receive duty power absorption schedules and/or power generation schedules for the entirety of batteries (2) from at least one external control center 9-i of the system 1.

In a further possible embodiment, the control center 5 is adapted to calculate switching schedules against planned power absorption schedules and/or power generation schedules for energy resources 8, 10, duty power absorption and/or power generation schedules for the batteries 2 and/or power absorption schedules and/or power generation schedules for the batteries 2 based on a deviation from a predetermined target value of at least one monitored power grid parameter. The control center 5 can be adapted to sum up at least one of the planned power absorption schedules and/or power generation schedules for the energy resources 8, 10 controlled by the at least one external control center 9-1, 9-2, the duty power absorption and/or power generation schedules for the batteries 2, the power absorption schedules and/or power generation schedules for the batteries 2 based on a deviation from a predetermined parameter target value of the at least one monitored power grid parameter to calculate a candidate schedule. The candidate schedule can then be optimized by the control center 5. The control center 5 can optimize the calculated candidate schedule on the basis of a utility of energy stored in the distributed batteries 2-i and/or life expectancy impacts of charging/discharging processes on the distributed batteries 2-i by varying the at least one planned power absorption schedule and/or power generation schedule for the energy resources 8, 10 controlled by the external control centers 9-1, 9-2 included in the summation.

In a further possible embodiment, the control center 5 is adapted to calculate a threshold per battery 2 of the deviation of the at least one grid parameter from the predetermined parameter target value. The control center 5 can calculate the thresholds for example through the following process:

i) identify the maximum power absorption required of the batteries 2 given the maximum expected oversupply of power and the corresponding deviation from a predetermined parameter target value of at least one monitored power grid parameter,
ii) identify the maximum allowable error of the maximum power absorption from i),
iii) define the first point in time for which the switching battery controllers 3 have not received a switching schedule yet as to,
iv) predict the power absorption for each battery 2 at t0 under the assumption that all low-frequency switches 3A are closed before to,
v) select the battery 2 with the smallest predicted non-zero power absorption and remove it from the set of batteries,
vi) if no battery 2 could be selected in v), abort the process and force the selection of additional planned power absorption schedules before t0 of energy resources 8, 10 connected to external control centers 9,
vii) sum the predicted power absorptions of all selected batteries 2 at t0 provided that the low-frequency switches of the selected batteries 2 are closed,
viii) if the maximum power absorption from i) exceeds the sum of predicted power absorptions at t0 from vi), continue at iv),
ix) if the sum from iv) exceeds the maximum power absorption from i) by more than the maximum allowable overfulfillment from ii), abort the process and force the selection of additional planned power absorption schedules before t0 of energy resources connected to external control centers 9,
x) determine the share of each selected battery 2 in the sum from vi),
xi) divide the interval between zero deviation of the grid parameter and the maximum deviation of the grid parameter into as many sub-intervals as selected batteries 2, each with a length proportional to the share of the battery 2 from x),
xii) identify the thresholds of the selected batteries 2 with the boundaries of the sub-intervals from xi),
xiii) identify the thresholds of all other batteries 2 with infinity,
xiv) add the batteries 2 removed in viii) to the set of other batteries,
xv) calculate the switching schedules starting at t0 for the as in the case without the threshold calculation, but only taking into account the other batteries 2 and
xvi) perform i)-xiv) but for power generation instead of power consumption, where a battery 2 whose switching battery controller 3 opens the low-frequency switch 3A contrary to the switching battery controller's switching schedule is considered to have generated as much power as it was expected to absorb under the switching schedule.

The metering units 3D of the switching battery controllers 3 can be connected via a communication infrastructure to a virtual meter 12 of the central controller 5 as shown in FIG. 2.

In the illustrated embodiment, the vehicle batteries 2-i are connected to the associated switching battery controller 3 via a battery charger 4. The battery charger 4 can charge the respective battery 3 according to a predetermined charging program which may take different forms. The simplest form of a charging program is a constant power charge-up to an upper charge limit SOCₘₐₓ of the battery 2-i. All other components of the system 1 must not have knowledge of the charging program of the battery charger 4. The purpose of the system can still be achieved due to the power absorption prediction. This is because for the power supply grid 7, the state of charge of the vehicle batteries 2 has no technical significance, only the power absorption at every point in time has because it can lead to over- or undersupply of the power supply grid 7. This is a significant advantage of the system 1 according to the present invention because this allows the connection of different types of battery chargers 4 without establishing an information interface. It is possible to provide simply a connection to the one- or three-phase AC of the power supply grid 7. The distributed batteries 2-i can comprise rechargeable batteries of any kinds of electric vehicles such as cars, trucks, e-bikes. The battery charger 4 is charging the vehicle battery 2 connected manually by a user to the battery charger 4. The vehicle battery 2 is always loaded by the battery charger 4. The vehicle battery 2 is not discharged. Accordingly, a conventional battery charger 4 can be used in the system 1.

The local controller or processor 3B of the switching battery controller 3 can switch the low-frequency switch 3A according to the received switching schedule SCH. The switching schedule SCH can be fuzzy (e.g. “somehow, absorb 1 kWh between 22:00:00 and 22:15:00 on Jan. 1, 2018”) or very accurate or concrete (e.g. “switch on exactly at 22:00:34 on Jan. 1, 2018 and switch off exactly at 22:01:12 on Jan. 1, 2018”). Further, the switching schedule SCH can be a mixture including both fuzzy and concrete schedule elements which may not overlap in time. In the given example, the controller 3D of the switching battery controller 3 would close the low-frequency switch 3A at 22:00:00 on Jan. 1, 2018, then integrate the power measured by the metering unit 3D until 1 kWh has been absorbed and then open the low-frequency switch 3A. In a possible embodiment, the connection between the local controller 3B and the low-frequency switch 3A can be simple. For example, an electromechanical relay 3A can be connected via unshielded thin wires to the processor 3B of the switching battery controller 3. This provides an advantage because in conventional implementations of battery chargers, a high-frequency connection insulated or robust against electromagnetic disturbances is required. Furthermore, in high-frequency switching setups significant currents are transmitted into the power supply grid 7 at frequencies higher than the grid target frequency. Since this can disturb the operation of radio and information technology equipment as well as cause damage to rotating equipment, strict limits must be imposed on these currents. This requires elaborate electromagnetical filtering between the power supply grid 7 and every high-frequency switching setup, which the present invention dispenses with entirely due to its low switching frequency.

The communication network 6 can be formed by a low-bandwidth and high-latency communication infrastructure compared to conventional infrastructures used for controlling energy resources. This is possible because the system 1 according to the present invention does still work even for a signal transmission with relative high latency due to the capability of the local controller 3B of the switching battery controller 3 to accept fuzzy schedules SCH from the control center 5. This allows to use relative simple technological communication mechanisms such as GPRS which is a significant advantage of the system 1 according to the present invention.

The system 1 allows to stabilize the power supply grid 7 according to the operation frequency f of the grid and operating voltage U while charging the plurality of distributed batteries 2-i. The stabilization is achieved by balancing power fed into the power supply grid 7 and power drawn from the power supply grid 7 by energy consumers and the switching battery controllers 3-i. If a vehicle battery 2-i is not fully loaded the utility of the battery 2 is diminished. For example, the driving range of an electric vehicle having an electric motor powered by a battery 2 is significantly reduced when the battery 2 is not charged completely. The battery is considered to be charged completely when the power prediction for the battery is reduced compared to its peak value by a factor of 3 or more. Further, the battery 2 is charged by the switching battery controller 3 energy-efficiently by taking into account optimal power operation points of the energy resources 8, 10. The optimal switching schedules for each switching battery controller 3 can be determined by the control center 5 using power predictions for all switching battery controllers 3-i and schedules offered by the external control centers 9-i.

FIG. 3 shows a flowchart of a possible exemplary embodiment of a method for efficient charging of distributed batteries according to a further aspect of the present invention. The distributed batteries are connected to a power supply grid via a low-frequency switch of a switching battery controller as illustrated in the system of FIG. 2. The method comprises in the illustrated embodiment two steps.

In a first step S1, power absorption predictions are calculated by a control center 5 for all switching battery controllers 3 in response to power measurements reported by the switching battery controllers 3 to the control center 5.

In a further step S2, the low-frequency electromechanical switch of a switching battery controller 3 is controlled according to a switching schedule SCH determined for the respective low-frequency electromechanical switch by the control center 5 on the basis of the calculated power absorption characteristics and on the basis of power absorption and/or power generation schedules of energy resources 8, 9 connected to the power supply grid 7.

The invention provides according to a further aspect a switching battery controller 3 for a rechargeable battery 2. A possible embodiment of the switching battery controller 3 according to an aspect of the present invention is illustrated in FIG. 2. The switching battery controller 3 comprises in the illustrated embodiment a low-frequency electromechanical switch 3A connectable to the battery charger 4 of the rechargeable battery 2. The switching battery controller 3 further comprises in the illustrated embodiment a processor 3B adapted to control the low-frequency electromechanical switch 3A according to a switching schedule SCH received from the control center 5 by a communication interface 3C of the switching battery controller 3. The switching battery controller 3 further comprises a metering unit 3D adapted to measure a current power absorbed by the battery charger 4 and to report the measured power absorption via the communication interface 3C of the switching battery controller 3 to the control center 5 of the system 1. In an alternative embodiment of the present invention, the metering unit 3D is adapted to measure the deviation of at least one grid parameter from its target value. In this alternative embodiment, the processor 3B is adapted to switch the low-frequency electromechanical switch 3A contrary to the schedule received from the control center 5 if the deviation of the at least one grid parameter exceeds a threshold also received from the control center 5.

The invention further provides according to a further aspect a control center 5 for a system 1 as shown in FIG. 2. The control center 5 is adapted to provide a switching schedule SCH for different switching battery controllers 3-i on the basis of power absorption predictions calculated by a processing unit of the control center 5 for all switching battery controllers 3-i in response to power measurements reported by the different switching battery controllers 3-i and on the basis of power generation and/or absorption schedules of energy resources 8, 10 connected to the power supply grid 7. In an alternative embodiment, the control center 5 is adapted to additionally provide thresholds for the deviation of at least one grid parameter to different switching battery controllers 3-i on the basis of a maximum expected power absorption and/or generation of the entirety of batteries 2 at a predetermined maximum expected deviation of the at least one grid parameter. In this embodiment, the control center 5 is adapted so that the reaction of the entirety of batteries 2 to the deviation of the at least one grid parameter is approaching a predetermined continuous response function within the predetermined acceptable margin of overfulfillment of the power supply grid 7.

In a possible implementation, the switching battery controller 3 can be integrated in a battery charger 4. The number and types of the vehicle batteries 2 can vary in different application scenarios. In a still further possible embodiment, several control centers 5-i can be provided for different groups of batteries communicating with each other via a private network 11. The system 1 allows for a fast charging of a plurality of distributed vehicle batteries 2 connected to the power supply grid 7 using the currently already operating energy resources 8, 10 connected to the power supply grid 7. The energy resources 8, 10 can further be operated at an operation point providing maximum efficiency. The energy resources 8, 10 comprise optimal operation points due to their technical implementation. For instance, a gas turbine power plant comprises a peak efficiency at full load. The system 1 according to the present invention comprising a control center 5 can make most efficient use of all already active energy resources reducing the necessity to ramp up additional energy resources during power consumption peak periods. Further, the number and capacity of necessary stand-by energy resources can be reduced in the system 1 according to the first aspect of the present invention.

FIG. 4 shows a possible exemplary embodiment of the system 1 for efficient charging of distributed vehicle batteries 2 of vehicles 14. As can be seen in FIG. 4, a vehicle battery 2 of a vehicle 14, such as a car or truck, can be connected to a battery charger 4-1 having a connection to the power supply grid 7 via an associated electromechanical switch 3A-1 of a switching battery controller 3-1 communicating with the control center 5 of the system 1, for instance via a communication network 6 as illustrated in FIG. 4. The control center 5 is adapted to provide a switching schedule SCH for the electromechanical switch 3A-1 of the respective switching battery controller 3-1 on the basis of power absorption predictions calculated by the control center 5 for the switching battery controllers 3 of the system 1 in response to power measurements reported by the different switching battery controllers 3 and on the basis of power absorption schedules and/or power generation schedules of different energy resources 8, 10 of the power supply grid 7. In the illustrated embodiment of FIG. 4, the control center 5 is further adapted to provide the switching schedule for the electromechanical switch such as the electromechanical switch 3A-1 of the switching battery controller 3-1 also on the basis of charging modes CM selected by users of different vehicles 14. The system 1 as illustrated in FIG. 1 can comprise a plurality of vehicle batteries 2-i integrated in different vehicles 14. Each vehicle battery 2-i of the plurality of vehicles 14-i can be connected via a battery charger 4-i at different times to the power supply grid 7 according to the needs and time schedules of the users of the vehicles 14, i.e. the vehicle drivers. Each vehicle battery 2-i of the plurality of vehicle batteries can comprise a different loading capacity. Further, the vehicle batteries 2-i of the plurality of vehicles can be plugged to the battery chargers 4-i at different times during the day according to the needs of the vehicle users. The control center 5 can calculate a switching schedule SCH individually for each electromechanical switch 3A-i of the plurality of electromechanical switches 3A within the different switching battery controllers 3 depending on the charging modes CM selected by the different users of the plurality of vehicles 14. Each user U can in a possible embodiment choose between different charging modes CM for charging the vehicle battery 2-i of his vehicle 14 by an associated battery charger 4-i. In a possible embodiment, the selection of the charging mode CM by a user U of a vehicle 14 can be performed by means of a user interface UI. The user interface UI can comprise a user interface implemented in a handheld mobile device or user equipment device 13 as illustrated in FIG. 4. Further, the user interface UI can also be implemented in the vehicle 14 comprising the rechargeable vehicle battery 2 or in a charging column comprising a switching battery controller 3 and a battery charger 4.

FIG. 5 illustrates schematically a user interface UI which can be used by a user or a driver of a vehicle to select a charging mode CM. In the illustrated exemplary embodiment, the user interface UI offers three different charging modes CM1, CM2, CM3 for selection by the user. If the user U selects the first charging mode CM1 the connected vehicle battery 2 of his vehicle 14 is charged by the battery charger 4 with a maximum charging rate. In contrast, if the user U selects the second charging mode CM2 the connected vehicle battery 2 of his vehicle is charged by the battery charger 4 under control of the switching battery controller 3 communicating with the control center 5. Further, if the user U selects the third charging mode CM3 the connected vehicle battery 2 of his vehicle 14 is charged by the battery charger 4 according to a specific charging time plan. In a possible embodiment, the charging time plan CTP can be input by the user U of the vehicle 14 also via the user interface UI. An example of a charging time plan CTP input by a user via the user interface UI in the third charging mode CM3 is illustrated in FIG. 7. The user U may in the illustrated example input on different days of the week departure and arrival times. In the third charging mode CM3 as illustrated in FIG. 7, the vehicle battery 2 of the vehicle 14 of the user U is exactly charged as indicated by the input charging time plan CTP. For example, on Monday charging is started after the input arrival time 18:00 provided that the vehicle battery 2 has been plugged into the battery charger 4 of the user.

FIG. 6 shows schematically a charging diagram for illustrating the operation of the system 1 according to the present invention as illustrated in FIG. 4. The vehicle battery 2 can be loaded up to 100% SoC in different ways. The vehicle battery 2 can be charged with a maximum charging rate according to curve I in the first charging mode CM1 as illustrated in FIG. 6. At a time tₛₜₐᵣₜ the motor of the vehicle 14 is started to run the vehicle. The third curve III illustrates the charging of the battery 2 with a minimum charging rate still sufficient to reach the 100% charging level at the start time tₛₜₐᵣₜ of the vehicle 14. In the second charging mode CM2, the connected vehicle battery 2 is charged by the battery charger 4 under control of the switching battery controller 3 communicating with the control center 5. In the second charging mode CM2, the vehicle battery 2 is charged not with the maximum charging rate but more slowly according to the switching schedule SCH received from the communication center 5. The charging rate in the second charging mode CM2 selected by the user via the user interface UI is adjusted according to the needs of the whole system 1 including the power supply grid 7. If there is power oversupply in the power supply grid 7 the charging rate in the second charging mode CM2 is increased by the control center 5 whereas if the power supply is not sufficient the charging rate in the charging mode CM2 is slightly decreased. The charging rate in the second charging mode CM2 is always kept at a level exceeding the charging rate of the curve III illustrated in FIG. 6 so that the vehicle battery 2 is fully charged also in the second charging mode CM2 at the starting time tₛₜₐᵣₜ of the vehicle 14.

The charging mode CM selected by a user U by means of the user interface UI is notified wireless to the control center 5 of the system 1 which is adapted to provide the switching schedule SCH for the electromechanical switch 3A of the switching battery controller 3 depending on the different charging modes CM selected by a plurality of users U of different vehicles 14. Each user U of a vehicle 14 can select a desired charging mode CM via the user interface UI of his mobile handheld device 13 or the user interface UI of his vehicle 14. Different users can select different charging modes CM. For instance, a first user may select a charging mode CM1 for charging his vehicle battery 2 with a maximum charging rate according to charging curve I as illustrated in FIG. 6, whereas another second user may select a second charging mode CM2 where the connected vehicle battery 2 is charged by the battery charger 4 under the control of the switching battery controller 3 communicating with the control center 5 of the system. A third user may select a third charging mode CM3 where the connected vehicle battery is charged by the battery charger 4 according to a charging time plan CTP input by the user of the vehicle 14. In an alternative embodiment, the charging time plan CTP can also be derived automatically from a previous driving routine of the vehicle 14 in the third charging mode CM3.

In the system 1 according to the present invention, a high number of different distributed vehicle batteries 2 might be connected via associated battery chargers 4 to the system 1 and a corresponding number of vehicle users U may select different charging modes CM according to their individual needs. For instance, a first group comprising a number N1 of users may select the first high-speed charging mode CM1, a second group of users comprising a number N2 of users may select the second moderate charging mode CM2 and a third group comprising N3 users may select the third charging mode CM3 and may input a charging time plan CTP. In a possible embodiment, the charging modes CM selected by the different groups of users are all reported to the control center 5 wireless or through a telecommunication network. Consequently, the control center 5 has knowledge about how many users have selected one of the three different charging modes CM1, CM2, CM3. This knowledge is taken into account when calculating the switching schedules SCH or the different electromechanical switches 3A of the plurality of switching battery controllers 3 of the system 1.

In a possible embodiment, the electrical power reserved by the control center 5 of the system 1 for charging a vehicle battery 2 for a specific user U is adapted by the control center 5 depending on the charging mode CM selected by the respective user U via the user interface UI. In a possible embodiment, the reserved electrical power associated with a vehicle battery 2 of a specific user U is reduced automatically if the user U selects the first charging mode CM1 and is increased automatically if the user U selects the second charging mode CM2. Further, the reserved electrical power associated with the vehicle battery 2 of a specific user U can be changed depending on a charging time plan CTP input by the user U or derived from the driving routine of the vehicle 14 in the third charging mode CM3. A reduction of the reserved electrical power associated with the vehicle battery 2 of a specific user U takes place as a consequence if the user U selects a first charging mode CM1 and forms a penalty since the high charging rate of the first charging mode CM1 reduces the charging time of the impatient user U but diminishes the capability of the whole system 1 to charge other distributed batteries of the system 1. By reducing the reserved electrical power associated with his vehicle battery 2 this user U has an incentive not to select the first charging mode CM1 and may select another charging mode CM. If the user U selects the second charging mode CM2 the reserved electrical power associated with his vehicle battery 2 is increased automatically. In the second charging mode CM 2, the charging time period for charging the vehicle battery 2 to a 100% charging level is higher, however, the lower charging rate employed in the second charging mode CM2 is beneficial to the whole system 1 because capabilities to load other distributed batteries 2 are less diminished than when charging the vehicle battery 2 with a maximum charging rate as done when selecting the first charging mode CM1. Further, the reserved electrical power associated with the vehicle battery 2 of a specific user U can be adapted depending on the charging time plan CTP such as illustrated in FIG. 7. For instance, if the user U selects departure and arrival times which lead to a charging of his vehicle battery 2 at peak demand times, the reserved electrical power for this user U might be reduced. In contrast, if the user U selects times where there is a low demand for electrical power, the reserved electrical power of this user might be increased. Accordingly, in the third charging mode CM3, there is an incentive for the user U to select charging times where the normal power supply demand is normally low. The method and system 1 according to the present invention as illustrated in the embodiment of FIG. 4 allows a grid-enhancing e-car charging for a plurality of distributed batteries 2, in particular vehicle batteries.

If a driver of a vehicle 14 needs a very fast charging of his vehicle battery 2 he may select the first fast-charging mode CM1 by pressing for instance a specific button of a user interface UI. This user interface UI can be implemented in a mobile handheld device 13 such as a smartphone of a user U. The user interface UI can also be implemented in the vehicle 14 of the user. A further alternative is that the user interface UI is implemented on a charging column including the battery charger 4.

The different vehicles 14 can belong in a possible embodiment to a vehicle fleet of an organization or logistic entrepreneur. In a possible embodiment, the user U is informed about the electric power reserved currently for his vehicle battery 2. For instance, the amount of reserved electrical power can be displayed on a display unit of the user interface UI. The reserved electrical power for a user U can be increased or decreased depending on the behaviour of the user U when selecting different charging modes CM. If the user U selects mostly the first charging mode CM1 his individual reserved electric power is reduced automatically and the reduction is visible to the user U on the user interface display. Further, if the user U mostly selects the second charging mode CM2 or the third charging mode CM3 with system-friendly charging times the reserved electrical power will be automatically increased and the increase will be visible to the user on the user interface display.

Further embodiments of the system 1 are possible. In a possible embodiment, the user U can provide the control center 5 with additional information about the vehicle battery 2 of his vehicle 14. The user may provide the control center 5 with the battery capacity of the vehicle battery 2 and/or the battery type of the vehicle battery 2. This additional information data can be used by the control center 5 when calculating the switching schedules SCH for the different electromechanical switches 3A of the distributed switching battery controllers 3 of the system 1.

In a further possible embodiment, a charging time plan CTP of the third charging mode CM3 is derived automatically from the driving routine of the vehicle 14. For instance, the driver of the vehicle 14 may leave his house or arrive at his house on a specific day such as Monday always about the same time. From this routine behaviour, a charging time plan CTP can be predicted and be supplied to the control center 5 of the system 1.

In a still further possible embodiment, the movement of vehicles 2-i belonging for instance to the same vehicle fleet of an organization can be coordinated by the control center 5 according to the calculated switching schedules. In this embodiment, the control center 5 coordinates the movement of the vehicles 14 such as trucks belonging to a logistic entrepreneur such that the charging of all vehicle batteries 2 of the fleet is performed most efficiently. The number of vehicle batteries 2 of vehicles 14 may correspond in a possible embodiment to the number of battery chargers 4 of the system 1. For instance, each private person or user U may have a vehicle 14 comprising an integrated vehicle battery 2 which can be plugged into a battery charger 4 belonging to the same user. In alternative embodiments, the number of vehicles 14 including integrated vehicle batteries 2 may exceed the number of battery chargers 4. In this embodiment, the battery chargers 4 can include public battery chargers not belonging to a specific person or an associated vehicle of a person. In a further possible implementation, a navigation system of a vehicle 14 can direct the vehicle 14 with the integrated vehicle battery 2 to an available battery charger 4-i of the system 1 which is not yet occupied by a vehicle battery to be loaded. The user U can input via the user interface UI of his vehicle 14 a command requiring the system 1 to guide the vehicle 14 to the next available free battery charger 4 for charging the vehicle battery 2.

In a further possible embodiment, the user U can select a charging mode CM for charging the vehicle battery 2 even before arriving at the available battery charger 4. In this embodiment, the control center 5 knows beforehand which charging mode CM will be used when the vehicle 14 arrives at the battery charger 4 and can take this into account when calculating the schedules SCH of the different distributed switching battery controllers 3 of the system 1.

In a further possible embodiment, the different battery chargers 4 can be integrated in charging columns wherein each battery charger 4 may provide a different possible maximum charging rate. In a possible embodiment, the control center 5 receives information from the associated switching battery controller 3 about the charging rate CR provided by the connected battery charger 4. In a possible embodiment, the control center 5 has information data about the different charging rates CRs of the distributed different battery chargers 4 and/or the selected charging modes CMs specified by the users U of the different vehicles 14. For instance, a user U having a vehicle 14 with a vehicle battery 2 with a high battery capacity connected to a battery charger 4 allowing a high charging rate CR will draw a high amount of electrical current from the system 1 if the user U selects the high-speed charging mode CM1. In contrast, if the vehicle battery 2-i of the user's vehicle 14 has only a low battery capacity and is connected to a battery charger 4 with a low charging rate CR, the electrical charge drawn from the system 1 and/or the power supply grid 7 will be lower even when the user selects a high-speed charging mode CM1.

In a further possible embodiment, the control center 5 can output information data via the user interface UI to the user indicating the expected starting time for charging the vehicle battery 2 completely according to the selected charging mode CM. Accordingly, after having input or selected the charging mode CM, the user U can see how long the charging of his battery 2 will take approximately in the current state of the system 1. For instance, if the user U selects the second moderate charging mode CM2 he may be informed via the user interface UI that the charging of the vehicle battery 2 will take approximately two hours. If the user is not satisfied with this he may change the charging mode CM, for instance to charging mode CM1. Then, the system 1 may give him a feedback how long the charging will now take, for instance one hour.

1. A system for efficient charging of distributed vehicle batteries of vehicles,
wherein each vehicle battery is connectable to a battery charger connected to a power supply grid via an electromechanical switch of a switching battery controller communicating with a control center of the system,
wherein the control center is adapted to provide a switching schedule for the electromechanical switch of the respective switching battery controller on the basis of power absorption predictions calculated by said control center for the switching battery controllers in response to power measurements reported by the switching battery controllers and on the basis of power absorption schedules and/or power generation schedules of energy resources of said power supply grid.

2. The system according to claim 1, wherein the control center is adapted to provide the switching schedule for the electromechanical switch of the switching battery controller also on the basis of charging modes selected by users of vehicles.

3. The system according to claim 2, wherein the charging mode for charging the vehicle battery of the vehicle by the battery charger is selected by a user of the vehicle via a user interface.

4. The system according to claim 2, wherein the selectable charging mode comprises
a first charging mode where the connected vehicle battery is charged by the battery charger with a maximum charging rate,
a second charging mode where the connected vehicle battery is charged by the battery charger under control of the switching battery controller communicating with the control center and
a third charging mode where the connected vehicle battery is charged by the battery charger according to a charging time plan input by a user of the vehicle and/or derived automatically from a driving routine of the vehicle.

5. The system according to claim 3, wherein the user interface comprises a user interface implemented in a handheld mobile device of a user and/or a user interface implemented in the vehicle comprising the rechargeable vehicle battery.

6. The system according to claim 2, wherein the charging mode selected by a user by means of the user interface is notified to the control center of the system which is adapted to provide the switching schedule for the electromechanical switch of the switching battery controller depending on the charging modes selected by users of different vehicles.

7. The system according to claim 2, wherein an electrical power reserved by the control center of the system for charging a vehicle battery of a specific user is adapted by the control center of the system depending on the charging mode selected by the respective user via the user interface.

8. The system according to claim 7, wherein the reserved electrical power associated with a vehicle battery of a specific user is reduced automatically if the user selects the first charging mode and is increased automatically if the user selects the second charging mode and/or wherein the reserved electrical power associated with the vehicle battery of a specific user is changed depending on a charging time plan input by the user or derived from the driving routine of the vehicle in the third charging mode.

9. The system according to claim 1, wherein the control center is adapted to determine the switching schedule for the electromechanical switch of the switching battery controller in response to the calculated power absorption predictions, the power absorption schedules and/or power generation schedules of the energy resources and in response to monitored power grid parameters.

10. The system according to claim 1, wherein the switching battery controller comprises a processor adapted to communicate with said control center via a communication interface of the switching battery controller and adapted to control the electromechanical switch of the switching battery controller according to the switching schedule determined by the control center for the electromechanical switch of the switching battery controller and received by said processor through the communication interface of the switching battery controller.

11. The system according to claim 1, wherein the switching battery controller comprises a metering unit adapted to measure a current power absorbed by a battery charger connected to the electromechanical switch of the switching battery controller and to report the measured power absorption to the control center which is adapted to calculate power absorption predictions based on previously reported power absorptions.

12. The system according to claim 1, wherein the control center is adapted to calculate power absorption predictions for a specific time period by evaluating previously reported absorptions of at least one corresponding time period in the past reported under matching circumstances.

13. The system according to claim 1, wherein the control center is connected to at least one control center of energy resources of a power plant operator to receive planned power absorption schedules and/or power generation schedules for the energy resources controlled by the respective control center of the power plant operator.

14. The system according to claim 9, wherein the control center is adapted to calculate for at least one monitored power grid parameter a power absorption schedule and/or power generation schedule for the vehicle batteries based on the deviation from a predetermined parameter target value of the at least one monitored power grid parameter.

15. The system according to claim 1, wherein the control center is adapted to receive duty power absorption schedules and/or power generation schedules for the entirety of vehicle batteries from at least one power plant control center.

16. The system according to claim 1, wherein the control center is adapted to calculate switching schedules against planned power absorption schedules and power generation schedules for energy resources, duty power absorption and/or power generation schedules for the vehicle batteries and/or power absorption schedules and/or power generation schedules for the vehicle batteries based on a deviation from a predetermined parameter target value of at least one monitored power grid parameter.

17. The system according to claim 13, wherein the control center is adapted to sum up at least one of the planned power absorption schedules and/or power generation schedules for the energy resources controlled by at least one external control center, the duty power absorption and/or power generation schedules for the vehicle batteries, the power absorption schedules and/or power generation schedules for the vehicle batteries based on a deviation from a predetermined parameter target value of at least one monitored power grid parameter to calculate a candidate schedule.

18. The system according to claim 17, wherein the control center is adapted to optimize the calculated candidate schedule on the basis of a utility of energy stored in the distributed vehicle batteries and/or life expectancy impacts of charging/discharging processes on the distributed vehicle batteries by varying the at least one planned power absorption schedule and/or power generation schedule for the energy resources controlled by at least one power plant control center included in the summation.

19. The system according to claim 11, wherein the metering units of the switching battery controllers are connected via a communication infrastructure to a virtual meter of the central controller.

20. A method for efficient charging of distributed vehicle batteries of vehicles, wherein each vehicle battery is connectable to a battery charger connected to a power supply grid via an electromechanical switch of a switching battery controller,
the method comprising:
calculating by a control center for all switching battery controllers power absorption predictions in response to power measurements reported by the switching battery controllers to the control center;
controlling the electromechanical switch of a switching battery controller according to a switching schedule determined for the respective electromechanical switch by said control center on the basis of the calculated power absorption characteristics and on the basis of power absorption and power generation schedules of energy resources of said power supply grid.

21. The method according to claim 19, wherein the switching schedule is determined by said control center also on the basis of charging modes selected by users of the vehicles.

22. A switching battery controller for a rechargeable battery of a vehicle said switching battery controller comprising:
an electromechanical switch connected to a battery charger of said rechargeable vehicle battery;
a processor adapted to control the electromechanical switch according to a switching schedule received from a control center by a communication interface of said switching battery controller, wherein the switching schedule is determined by the control center on the basis of calculated power absorption characteristics and on the basis of power absorption and power generation schedules of energy resources of the power supply grid; and
a metering unit adapted to measure a current power absorbed by the battery charger and adapted to report the measured power absorption via the communication interface of said switching battery controller to said control center.

23. A control center for a system according to claim 1,
said control center being adapted to provide switching schedules for different switching battery controllers on the basis of power absorption predictions calculated by said control center for all switching battery controllers in response to power measurements reported by the switching battery controllers and on the basis of switching schedules of energy resources of said power supply grid.

24. The control center according to claim 23, wherein the control center is further adapted to provide the switching schedule also on the basis of charging modes selected by users of vehicles.

25. A charging column for a system according to claim 1, comprising a switching battery controller and a battery charger.
